(19) United States
(12) Patent Application Publication
(10) Pub. No.: US 2016/0377337 A1
(43) Pub. Date: Dec. 29, 2016

(54) DOMESTIC REFRIGERATION DEVICE HAVING A STORAGE REGION AND A WETTING APPARATUS, IT BEING POSSIBLE TO MOVE THE TANK OF SAID WETTING APPARATUS RELATIVE TO AN ATOMIZER UNIT

(71) Applicant: BSH HAUSGERAETE GMBH

(72) Inventors: AXEL KLUGER, GIENGEN (DE); BERND METTEL, HERBRECHTINGEN (DE); ANDREAS SCHUESSLER, MUENCHEN (DE); DARJA WENDEL, TROSSINGEN (DE)

(21) Appl. No.: 15/103,946

(22) PCT Filed: Dec. 4, 2014
(86) PCT No.: PCT/EP2014/076613

§ 371 Date: Jun. 13, 2016

(30) Foreign Application Priority Data
Dec. 12, 2013 (DE) 102013225716.3

(51) Int. Cl. F25D 17/04; B01F 3/04; F25D 23/12

(52) U.S. Cl. CPC F25D 17/042; F25D 23/12; B01F 3/04021; F25D 2317/04; B01F 2215/008

(57) ABSTRACT

A domestic refrigeration device includes an interior space in which a partial volume is formed as a separate storage region into which food products can be placed, and a wetting apparatus with which a fluid can be introduced into the storage region independently of the rest of the interior space. The wetting apparatus has a tank containing the fluid to be atomized and an atomizer unit connected to the tank for conducting the fluid. The tank can be moved relative to the atomizer unit in order to be filled with the fluid.

The invention relates to a domestic refrigeration device having an interior space in which a partial volume is formed as a separate storage region into which food products can be placed. The domestic refrigeration device has a wetting apparatus with which a liquid fluid can be introduced into the storage region independently of the rest of the interior space. The wetting apparatus comprises a tank for atomization using a fluid, and an atomizer unit which is connected to the tank for conducting fluid.

Domestic refrigeration devices, such as, for example, a fridge, are known from the prior art which have an interior space for placing food products. This interior space is conventionally limited by an interior container and closed at the front by a door. Cold air is introduced into the interior space, and this is generated by a refrigeration circuit. A storage region is formed in the interior space so as to be separate therefrom and is also designed to receive food products, wherein introduction of a fine water mist is made possible here, with this having a positive impact on the storage quality of these fresh food products. In the case of fresh fruit and vegetables therefore, the product quality is maintained for a particularly long time as a result of wetting during storage. Wetting of this kind by means of a water mist also cools these food products more quickly, moreover.

Fruit and vegetables are products which still have an active metabolism even after harvesting. Nutritious ingredients are lost as a result of transpiration and respiration processes and fresh mass is lost owing to loss of moisture.

These processes can be reduced or slowed down by way of suitable storage conditions. The closer the storage temperature is to the freezing point of the respective product, the lower the ingredient losses are since metabolism processes come to a virtual standstill. Freshly stored food products can be cooled, moreover, by active wetting during storage by way of evaporative cooling, and this also ensures improved preservation of the product quality.

Transpiration losses can mainly be avoided by observing the equilibrium moisture content of the stored goods in the storage environment. For example, this is achieved by appropriate packaging or protected storage in sealed storage boxes. This is already being implemented in refrigeration devices in special vegetable trays with moisture control.

Furthermore, there are systems which attempt to keep the air moisture content high, and therewith the transpiration losses of stored fruit and vegetables low, by evaporation wetting inside the vegetable tray, by rewetting or active atomization of water in the vegetable tray. Systems for active wetting are known from the food products retail trade, moreover. During product presentation of unpackaged goods active wetting occurs in order to reduce product moisture losses. The limits of the systems in their capacity for keeping products fresh in domestic refrigeration devices are always given by the underlying refrigeration engineering system and the dependency of the loading of the corresponding storage regions. In what are known as no-frost systems very high dehumidification occurs therefore, and this can potentially have an adverse effect on the storage of fruit and vegetables. On the other hand, there are systems in which good functionality is only given with a high level of loading and therewith a high moisture input.

Previous systems in domestic refrigeration systems are only capable of maintaining the given product status within said limits. An improvement in product quality in the sense of an additional protective function or in the sense of the restoration of freshness that has already been lost is not possible.

Domestic refrigeration in which a separate storage region of this kind is formed in an interior space are known from DE 10 2009 029 139 A1 and DE 10 2009 029 141 A1.

It is the object of the present invention to create a domestic refrigeration device in which filling of the wetting apparatus is achieved easily and without spillages.

An inventive domestic refrigeration device comprises an interior space in which a partial volume is formed as a separate storage region. Food products can be placed in this storage region. The domestic refrigeration device also comprises a wetting apparatus with which a fluid can be introduced into the storage region independently of the rest of the interior space, and the wetting apparatus has a tank containing the fluid which is to be atomized. The domestic refrigeration device having the wetting apparatus also comprises an atomizer unit which is connected to the tank for conducting fluid.

A fundamental idea of the invention can be seen in that the tank can be moved relative to the atomizer unit. This results in simpler handling of an individual component of the wetting apparatus, namely the tank, in relation to filling with the fluid. Filling is consequently also less susceptible to spillage.

In this connection the tank can formed so as to be non-destructively separated from the atomizer unit. As a result the tank can be completely removed, whereby it can also be cleaned more easily as an individual component and can also be filled remote from the domestic refrigeration device.

It can also be provided that the tank is arranged so as to be movable in a straight horizontal direction for the purpose of removal. As a result the tank can be brought into the respective position by way of a very straight movement and, in turn, a jolt-free and therewith low-spillage embodiment can also be achieved here by this simple movement sequence.

It is preferably provided that in an alternative embodiment the tank is mounted so it can be pivoted with respect to the atomizer unit about a horizontal axis. In particular, it is provided with an embodiment of this kind that the tank remains on the wetting apparatus and can then be brought into a filling position by the pivoting movement. In this position it is then oriented obliquely forwards in a manner similar, for example, to a tipper box, and can then be filled from above. As a result easy and spillage-free filling is possible without the tank having to be separated. Tilting means that it is brought into an easily accessible exposed position in respect of a filling option, without having to remove the tank. As a result there is no need for possibly complex re-coupling to the housing of the wetting apparatus to be carried out.

It is preferably provided that at a lower leading end the tank can be pivoted about an axis oriented in the width direction of the domestic refrigeration device. The advantages of this embodiment that are cited above are enhanced again as a result.

The storage region preferably has a drawer, and in the width direction at least the tank of the wetting apparatus is arranged, so as not to overlap, outside and next to the drawer at the same height level as the drawer at least in certain sections. These adjacent components which are arranged side by side in a gap in the width direction mean that a very compact construction is achieved which nevertheless enables user-friendly accessibility to the wetting apparatus and to the drawer. Separate movement of the two components in the depth direction of the domestic refrigeration device is possible without restriction. The arrangement of the components side by side so as not to overlap also means that the useful volume of the drawer is not affected in the depth and width directions. A base of the drawer which is, for example, uneven in certain sections can be prevented in this way, so food products can be amply placed into the drawer and so as to be protected from falling.

It is preferably provided that in the width direction the tank and the atomizer unit are arranged, so as not to overlap, next to the drawer and at the same height level as the drawer at least in certain sections. More or less the entire wetting apparatus is consequently positioned appropriately, promoting the advantages mentioned above.

It is preferably provided that at the front the tank has a handle, so handling of the tank during removal and insertion, as well as basically during operation, can be gripped more securely.

It is preferably provided that a wall section of the front is designed so it can be gripped behind from below, again improving reliable and secure operation by a user.

It is preferably provided that the opening of the tank is designed in the manner of a funnel. This embodiment creates a filling option which facilitates a larger volume and therewith faster filling without this resulting in imprecise filling or undefined filling.

It is preferably provided that the opening can be closed by a cover. This prevents undesirable spilling over when the tank is being moved as well as when the domestic refrigeration device is being moved.

It is preferably provided that the wetting apparatus has a housing which in a bottom part has at least some components of the atomizer unit. An upper part top panel is formed in an upper part of the housing, and this covers a slide-in compartment for the tank from above. When this housing is viewed in a vertical cross-section, a U-shape which is open at the front is therefore formed, with the slide-in compartment being formed in the free space between the legs of the U shape. An embodiment of this kind achieves versatile embedding of the tank in the housing, so mechanically stable positioning is achieved. Furthermore, this specific form of the housing also favors accommodation of the components of the atomizer unit and supplying of the atomized fluid from the wetting apparatus to the storage region because outlet openings for the generated mist can also be formed relatively high up on the wetting apparatus as a result of this embodiment, so the atomized fluid can be supplied to the storage region relatively high up in respect of the height, and a very short connection between the wetting apparatus and the storage region, in particular the drawer, is sufficient for this purpose.

It is preferably provided that the upper part top panel has a mist outlet opening that faces the drawer. The advantages mentioned above are enhanced once again by this embodiment.

It is preferably provided that the wetting apparatus and a drawer, which can be moved relative thereto, of the storage region are connected by a line connection permanently coupled along the maximum movement path of the drawer, even when the drawer is moved, in order to introduce mist into the drawer. The fluid coupling between the wetting apparatus and the drawer is maintained even when the drawer is pulled out or pushed in. As a result this very important interface, in particular, is not separated and then joined together again when the drawer is moved in the horizontal direction. As a result it is permanently functionally reliable and a supply of mist into the storage region which is low in or free from leakage is possible.

A line connection of this kind can be intrinsically stable in terms of length but can be achieved by a flexible line which can therefore be deformed. This can occur, for example, by way of a hose.

It can also be provided, however, that this line connection is telescopic so it is it also intrinsically changeable in length.

It is preferably provided that the wetting apparatus and a drawer, which can be moved relative thereto, of the storage region are connected by a coupling, coupled only in the pushed-in end position of the drawer, as a connection for introducing mist into the drawer. With this embodiment automatically induced decoupling occurs therefore when the drawer is pulled out of the end position, so no more mist can be conducted into the drawer and the storage region. An independently coupling and decoupling connection of this kind improves the handling of the drawer since the drawer can be completely separated from the interior space in a user-friendly manner without decoupling of a line connection actively performed by the user.

It is preferably provided that a cover, delimiting the storage region, for covering a drawer delimiting the storage region does not extend over the wetting apparatus in the width direction and instead only a partition arranged on the cover extends directly over the wetting apparatus as well. This embodiment means this wetting apparatus is also more or less covered from above, so firstly, viewed in the width direction, containers or food products arranged thereabove can be disposed in this surface area as well. A larger surface area can therefore be used here as well. Secondly, this dimensioning of the cover provides protection for the wetting apparatus formed therebelow, so there is no direct exertion of forces from above by the food products or other components on the wetting apparatus.

It is preferably provided that a storage compartment for food products, which is separate from the storage region, is formed behind the wetting apparatus in the depth direction of the domestic refrigeration device. Even if, when viewed in the depth direction, the wetting apparatus is very compact, and therefore extends over a depth which is smaller than that of the drawer, this existing free space is still used accordingly in the form of the storage compartment for storing food products. It is preferably provided that this storage compartment can be closed directly by a cover. This storage compartment can consequently also be thermally separated from the remaining interior space and an individual option for specific food products for storing can then also be created.

It is preferably provided that the tank is designed to receive and hold a separate container filled with the fluid. An advantageous embodiment of this kind means that containers already filled with a specific fluid, which can then already be purchased as such, can be poured into the tank and the tank can therefore be equipped therewith. For this purpose it can preferably be provided that the tank is also designed for self-opening of this container, which is triggered on insertion thereof. For this purpose a mandrel or the like can be provided at a specific location, for example, in order to then open the introduced container optionally also at a separation point which can be pierced particularly easily. It can then preferably also be provided that a container of this kind can be supplied with different fluids or different fluid mixtures, so pre-prepared fluid mixtures can also be atomized in this connection. With an embodiment of this kind the user does not then have to laboriously produce a fluid mixture of this kind himself and independently introduce it into the tank.

At the upper side the tank preferably has an opening for filling or pouring-in the fluid. Simple and targeted filling is possible as a result of this locally specified arrangement of the opening, without the fluid being poured to a large extent outside of the tank and the surroundings of the tank therefore becoming undesirably wet. Furthermore, this local arrangement of the opening means that the tank is always already arranged in an orientation in the space in which it needs to be arranged an oriented accordingly on the device, so no extensive movements or rotations are required either which would then likewise possibly cause spillage of the fluid.

Further features of the invention result from the claims, figures and the description of the figures. The features and combinations of features mentioned above in the description as well as the features and combinations of features mentioned below in the description of the figures and/or shown solely in the figures can be used not just in the respectively disclosed combination but also in other combinations or alone, without departing from the scope of the invention. Embodiments of the invention which are not explicitly shown and illustrated in the figures but emerge and can be created by separate combinations of features from the illustrated statements should therefore also be regarded as incorporated and disclosed.

Exemplary embodiments of the invention will be illustrated in more detail below with reference to schematic drawings, in which:

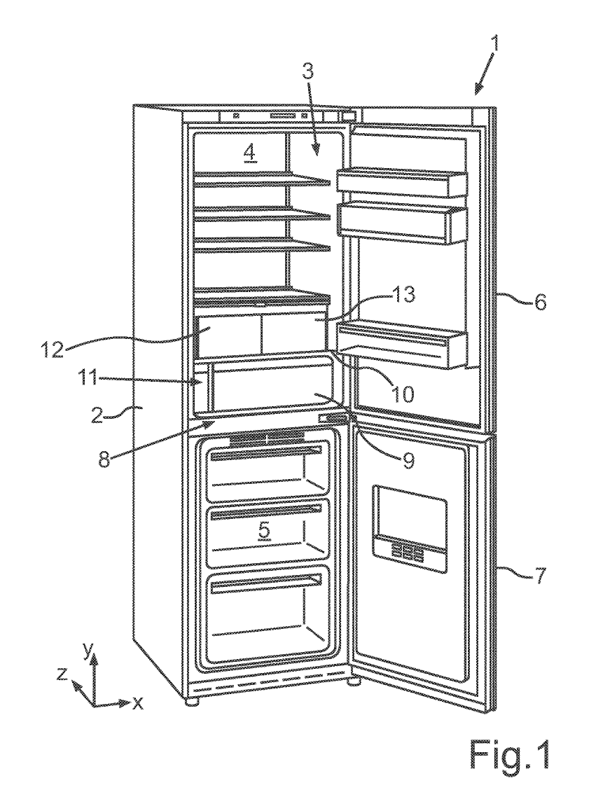

FIG. 1 shows a schematic perspective view of an exemplary embodiment of an inventive domestic refrigeration device,

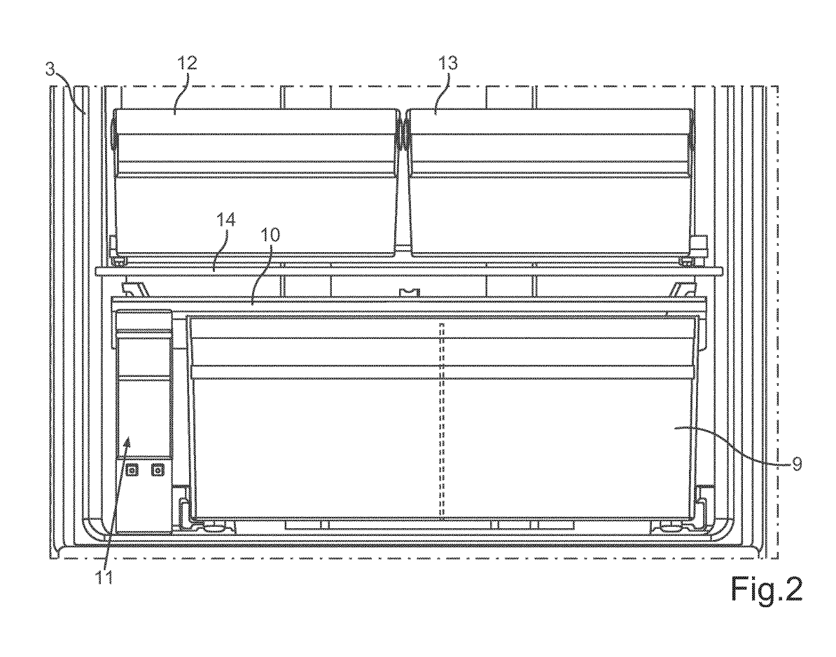

FIG. 2 shows a front view of a detail of the domestic refrigeration device according to FIG. 1,

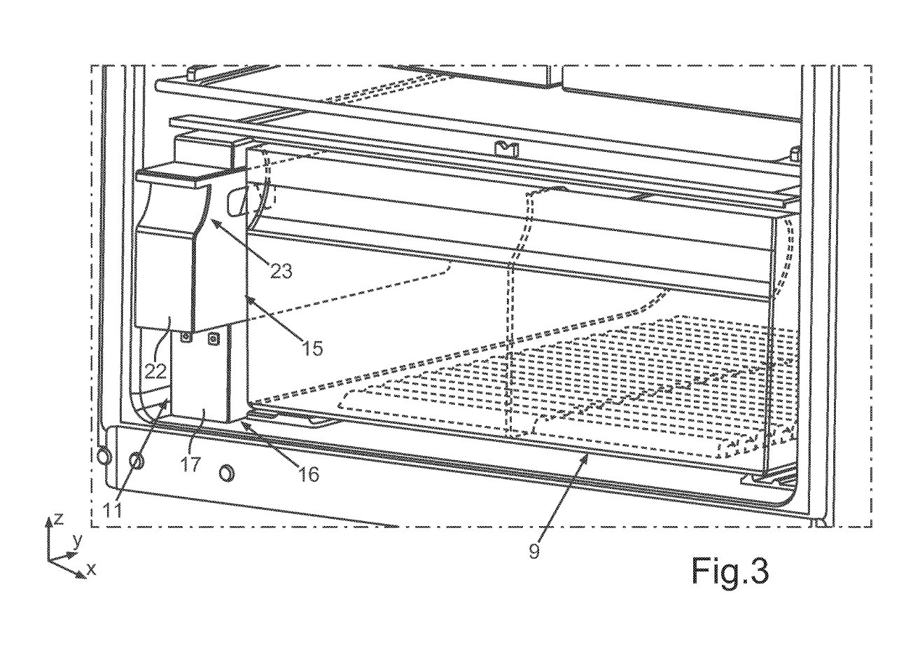

FIG. 3 shows a perspective view of the detail in FIG. 2 with partially pulled-out tank of the wetting apparatus,

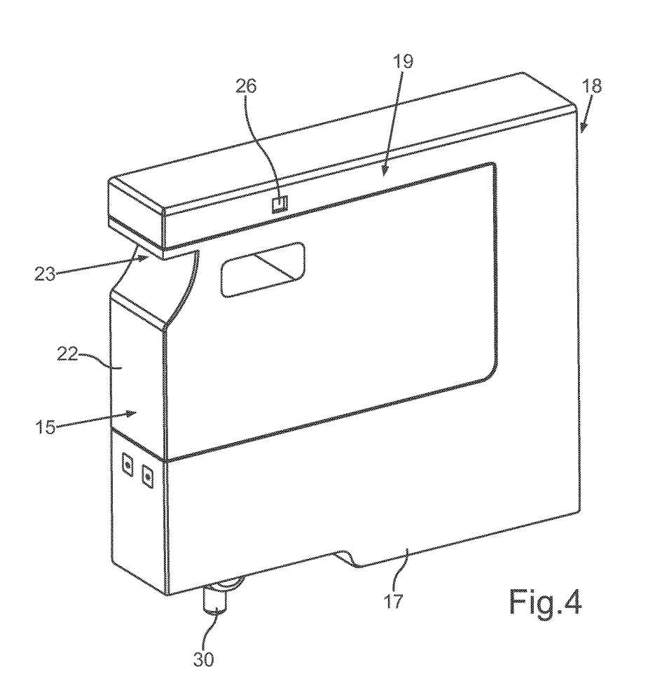

FIG. 4 shows a perspective view of an exemplary embodiment of the wetting apparatus,

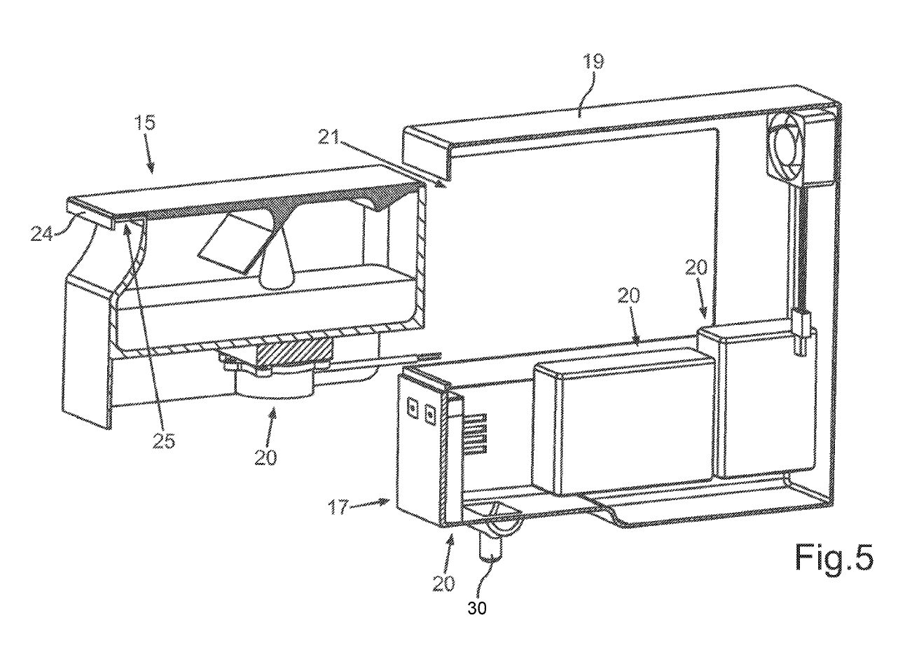

FIG. 5 shows a perspective sectional, exploded view of the wetting apparatus according to FIG. 4,

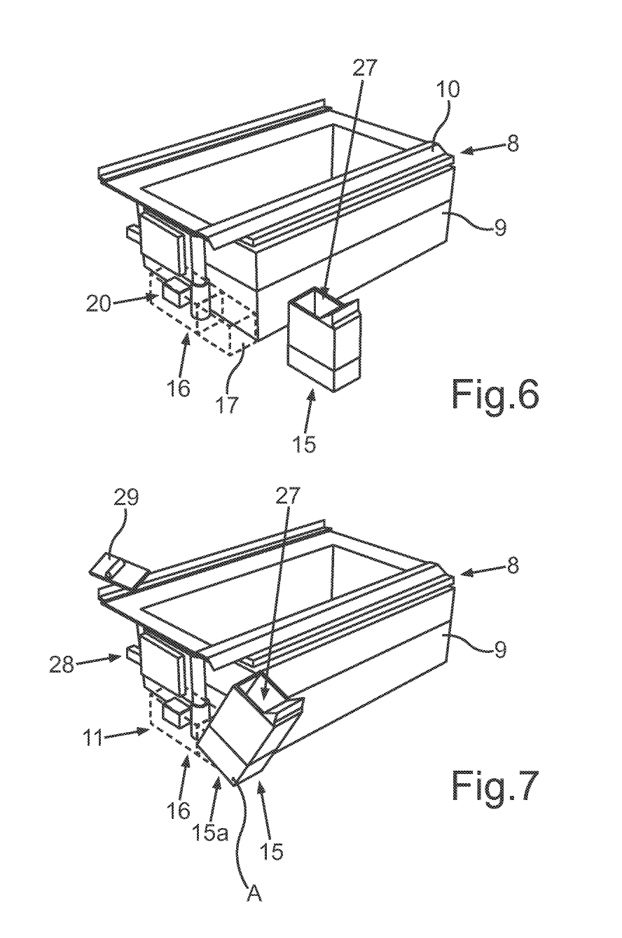

FIG. 6 shows a perspective view of a further exemplary embodiment of a detail of the domestic refrigeration device according to FIG. 1 having the storage region and a wetting apparatus from which a tank has been completely removed, and

FIG. 7 shows a perspective view of a further exemplary embodiment of the domestic refrigeration device in which the components having the storage region and the wetting apparatus are shown.

Identical elements or elements with the same function are provided with the same reference numerals in the figures.

FIG. 1 shows in a schematic perspective view a domestic refrigeration device 1 which can be a refrigerator or a freezer or a fridge freezer.

The domestic refrigeration device 1 comprises a housing 2 which surrounds an interior container 3. With its walls the interior container 3 delimits an interior space 4 which is designed to receive food products. Furthermore, the same interior container 3, or a different interior container, delimits a further interior space 5 in which food products can also be placed.

At the front the interior spaces 4 and 5 can be closed by separate doors 6 and 7 respectively.

The domestic refrigeration device 1 also comprises a refrigeration circuit by means of which the appropriate temperature control can be created in the interior spaces 4 and 5. The refrigeration circuit comprises for this purpose, in particular, an evaporator, a condenser and a compressor and corresponding connecting lines, in which a coolant circulates.

In the exemplary embodiment a separate storage region 8 is formed in the interior space 4. The storage region 8 is formed by a drawer 9 which can be pushed in the depth direction, and therefore in the z direction, and a cover 10 covering the drawer 9 from above.

The refrigeration circuit which has already been mentioned is formed such that an ambient humidity different from the rest of the partial volume of the interior space 4 can be adjusted in the storage region 8. In this connection the storage region 8 can preferably be a compartment in which, in particular, temperatures between 0° C. and 4° C. are adjusted. The temperatures in the rest of the interior space 4 are preferably slightly higher or can be adjusted by a user so as to be higher.

A wetting apparatus 11 is provided for appropriate defined adjustment of the ambient humidity in the storage region 8. Viewed in the width direction, and therefore in the x direction of the domestic refrigeration device 1, this is arranged next to the drawer 9 so as not to overlap and, furthermore, is positioned in the vertical direction, and therefore in the y direction, at least in certain sections, in particular over its entire height, at the same level as the drawer 9. The wetting apparatus 11, like the drawer 9, is accessible at the front when the door 6 is open.

In the width direction the cover 10 extends not just over the drawer 9 but also beyond the wetting apparatus 11, so this is also covered from above by the cover 10. As may also be seen an arrangement of further containers, in particular in the form of drawers 12 and 13, is provided above the cover 10.

FIG. 2 shows in an enlarged diagram a view of the domestic refrigeration device 1 in the region of the wetting apparatus 11 and the storage region 8. As may be seen in FIG. 2, the wetting apparatus 11 extends substantially over the same height as the drawer 9.

The wetting apparatus 11 is formed with a rectangular front and in its overall three-dimensional design is cuboid-shaped.

The wetting apparatus 11 is designed to bring sufficient moisture into the storage region 8. For this purpose it can comprise a fan or a blower that is present anyway. As may also be seen from the view in FIG. 2, arranged above the cover 10 is a partition 14 on which the drawers 12 and 13 are displaceably arranged.

FIG. 3 shows a perspective view of the partial illustration in FIG. 2. In contrast to the view in FIG. 3, a tank 15 of the atomizer unit 11 has been partially pulled out. In addition to the tank 15 the wetting apparatus 11 comprises a housing 16 which has a lower part 17 and an upper part 18 (FIG. 4) with an upper part top panel 19. At least some components of an atomizer unit 20 (FIG. 5) are arranged in the lower part 17 (FIG. 5). A slide-in compartment 21 for the tank 15 is formed by the U shape of the housing 16 which is open at the front.

The tank 15 can be pulled out in the horizontal depth direction, and therefore in the z direction, from the housing 16, and therefore the slide-in compartment 21. In the embodiment illustrated here the tank 15 can be completely separated from the housing 16. It can therefore be filled outside of the device, for example at a tap.

At a front side 22 the tank 15 comprises a handle 23. It is possible to grip behind a wall section 24 (FIG. 5) in a recessed grip 25.

The housing 16 is arranged in the interior space 4 so as to be mechanically coupled and is, in particular, immovably secured therein. The tank 15 is led and also held, in particular, by way of guides (not shown) in the slide-in compartment 21.

On a side facing the drawer 9 a mist outlet opening 26 is formed in the upper part top panel 19, from which opening the mist generated from the fluid, in particular the water which is contained in the tank 15 and atomized by the atomizer unit 20, exits into the storage region 8. For introduction into the drawer 9 a fluid coupling is provided between the outlet opening 26 and an inlet opening, in particular on the drawer 9. This can be designed such that a permanent connection, for example a fluid connection implemented by a line connection, is formed. This fluid-conducting connection can also be maintained therefore with a movement of the drawer 9 relative to the housing 16.

It can also be provided, however, that the wetting apparatus 11 and a drawer 9, which can be moved relative thereto, of the storage region 8 have a connection for the introduction of mist into the drawer 9 by way of a coupling coupled only in the inserted end position of the drawer 9.

FIG. 4 and FIG. 5 show, for example, an anchoring pin 30 with which, in particular, the housing 16, inter alia, can be mechanically secured at the base.

In a perspective view FIG. 6 shows a further exemplary embodiment in which a tank 15 is likewise designed to be completely separable from the housing 16. The tank 15 has, as is also preferably the case with tank 15 and as has already been illustrated, an opening 27 at the top by which filling of the tank 15 with fluid, in particular water, is possible.

FIG. 7 shows a further exemplary embodiment in which, in a perspective view, likewise only the storage region 8 of the domestic refrigeration device 1 is shown. In this embodiment the tank 15 is not completely separable from the housing 16, but is pivotally arranged thereon. In this embodiment a bearing is therefore provided at a leading lower end 15a of the tank 15, by which bearing an axis A is defined which extends in the width direction, and therefore in the x direction. The tank 15 can therefore be pivoted about a horizontal axis of this kind, with the outwardly pivoted and therefore forward-folded state of the tank 15 being shown in FIG. 7. Filling can then occur via the opening 27 in this case as well and when the tank 15 is completely full it can be pivoted back into is vertical end position again.

Furthermore, it is provided in this embodiment that in the depth direction, and therefore in the z direction, behind the wetting apparatus 11 a further storage compartment 28 is formed which can be closed from above by a cover 29, which is shown in the removed state in FIG. 7. This storage compartment 28 is designed to receive further food products and extends in the width direction at most over the width of the free space which remains between the drawer 9 and a side wall of the interior container. The drawer 9 is then not constricted thereby in the width direction, so its useful volume is not restricted here either. Furthermore, the entire volume space of the interior container in the vicinity of the storage region 18 and the wetting apparatus 11 is optimally equipped and utilized as a result of this additional storage compartment 28, however.

An opening 27 in the tank 15 is preferably funnel-shaped, so, in respect of introducing as large a quantity as possible, filling can occur in the shortest time possible without undesirable spillage.

This storage compartment 28 can also be formed in the other embodiments.

In a further embodiment it can be provided that the tank 15 is designed to receive a container that is separate from it, with the fluid to be atomized then being contained in the container. A container of this kind can then already be acquired as such, completely filled as a cartridge, and be inserted in the tank 15 accordingly. Appropriate filling with the fluid is then no longer necessary, so, firstly, spilling over or impure filling is prevented. Furthermore, with a cartridge of this kind a specific mixture of a fluid can be provided already mixed, so a user no longer has to perform such mixing himself in this case either. It can be provided that an element, for example a mandrel or the like, is present in the tank 15, and this brings about automatic opening of the container when the tank 15 is introduced. Once the cartridge is empty it can be removed and disposed of and then another new cartridge can be inserted.

### LIST OF REFERENCE CHARACTERS

1 domestic refrigeration device
2 housing
3 inner container
4 interior space
5 interior space
6 door
7 door
8 storage region
9 drawer
10 cover
11 wetting apparatus
12 drawer
13 drawer
14 partition
15 tank
15a lower end
16 housing
17 lower part
18 upper part
19 upper part top panel
20 atomizer unit
21 slide-in compartment
22 front
23 handle
24 wall section
25 recessed grip
26 mist outlet opening
27 opening
28 receiving compartment
29 cover
30 anchoring pin
A axis

1-15. (canceled)

16. A domestic refrigeration device comprising:
an interior space, said interior space having a partial volume formed as a separate storage region into which food products can be placed and said interior space having a remaining volume; and
a wetting apparatus for introducing a fluid into said storage region independently of said remaining volume of said interior space, said wetting apparatus having a tank for receiving the fluid to be atomized, and said wetting apparatus having an atomizer unit connected to said tank for conducting the fluid;
said tank being movable relative to said atomizer unit for filling said tank with the fluid.

17. The domestic refrigeration device according to claim 16, wherein said tank is non-destructively separable from said atomizer unit for filling said tank.

18. The domestic refrigeration device according to claim 17, wherein said tank is movable in a straight horizontal direction for removal.

19. The domestic refrigeration device according to claim 16, wherein said tank is pivotably mounted relative to said atomizer unit about a horizontal axis for filling said tank.

20. The domestic refrigeration device according to claim 16, wherein said tank has a lower leading end being pivotable about an axis oriented in a width direction of the domestic refrigeration device for filling said tank.

21. The domestic refrigeration device according to claim 16, wherein said tank has an upper side with an opening formed therein for filling said tank with the fluid.

22. The domestic refrigeration device according to claim 21, wherein said opening is a funnel.

23. The domestic refrigeration device according to claim 21, which further comprises a cover for closing said opening.

24. The domestic refrigeration device according to claim 16, wherein said storage region has a drawer with a height level, and at least said tank in a width direction does not overlap outside and next to said drawer at least in certain sections and is disposed at said height level of said drawer.

25. The domestic refrigeration device according to claim 24, wherein said tank and said atomizer unit in said width direction do not overlap next to said drawer at least in certain sections and are disposed at said height level of said drawer.

26. The domestic refrigeration device according to claim 16, wherein said tank has a front and a handle at said front to be gripped behind from below as a recessed grip.

27. The domestic refrigeration device according to claim 26, wherein said handle is a wall section.

28. The domestic refrigeration device according to claim 16, wherein said atomizer unit has components, said wetting apparatus includes a housing having a bottom part containing at least some of said components of said atomizer unit, an upper part having a slide-in compartment for said tank and an upper part top panel covering said slide-in compartment from above.

29. The domestic refrigeration device according to claim 28, wherein said storage region has a drawer, and said upper part top panel has a mist outlet opening formed therein facing said drawer.

30. The domestic refrigeration device according to claim 16, wherein:
said storage region has a drawer being movable along a maximum movement path relative to said wetting apparatus; and
said wetting apparatus and said drawer are interconnected by a line connection being permanently coupled along said maximum movement path even upon movement of said drawer, in order to introduce atomized fluid into said drawer.

31. The domestic refrigeration device according to claim 16, wherein:
said storage region has a drawer being movable relative to said wetting apparatus into a pushed-in end position; and
said wetting apparatus and said drawer are interconnected by a coupling being coupled only in said pushed-in end position, as a connection for introducing atomized fluid into said drawer.
